(19) United States
(12) Patent Application Publication
(10) Pub. No.: US 2010/0295757 A1
(43) Pub. Date: Nov. 25, 2010

(54) PLASMA DISPLAY PANEL

(76) Inventors: Jeonghyun Hahm, Gumi (KR); Heerak Kim, Gumi (KR)

Correspondence Address: BIRCH STEWART KOLASCH & BIRCH, PO BOX 747, FALLS CHURCH, VA, 22040-0747, US

(21) Appl. No.: 12/678,238

(22) PCT Filed: Nov. 21, 2008
(86) PCT No.: PCT/KR08/06889

§ 371 Date: Mar. 15, 2010

(30) Foreign Application Priority Data
Jan. 9, 2008 (KR) 10-2008-0002732

(51) Int. Cl. G09G 3/28

(52) U.S. Cl. 345/60

(57) ABSTRACT

A plasma display panel is disclosed. The plasma display panel includes a scan electrode and a sustain electrode positioned parallel to each other. Each of the scan electrode and the sustain electrode includes a line portion crossing the address electrode, a first connecting portion and a second connecting portion that extend from the line portion in a direction parallel to the address electrode, a third projection that projects from the first connecting portion in a direction parallel to the line portion, and a fourth projection that projects from the second connecting portion in the direction parallel to the line portion. The third projection and the fourth projection are separated from each other.

### TECHNICAL FIELD

Exemplary embodiments relate to a plasma display panel.

### BACKGROUND ART

A plasma display panel includes a phosphor layer inside discharge cells partitioned by barrier ribs and a plurality of electrodes.

When driving signals are applied to the electrodes of the plasma display panel, a discharge occurs inside the discharge cells. In other words, when the plasma display panel is discharged by applying the driving signals to the discharge cells, a discharge gas filled in the discharge cells generates vacuum ultraviolet rays, which thereby cause phosphors positioned between the barrier ribs to emit light, thus producing visible light. An image is displayed on the screen of the plasma display panel due to the visible light.

### DISCLOSURE OF INVENTION

### Technical Problem

Exemplary embodiments provide a plasma display panel capable of preventing an excessive reduction in a luminance of an image and reducing a discharge current by improving electrodes on a front substrate.

### Technical Solution

In one aspect, a plasma display panel comprises a front substrate on which a scan electrode and a sustain electrode are positioned parallel to each other, a rear substrate on which an address electrode is positioned to cross the scan electrode and the sustain electrode, and a barrier rib that is positioned between the front substrate and the rear substrate to partition discharge cells, wherein each of the scan electrode and the sustain electrode includes a line portion crossing the address electrode, a first connecting portion and a second connecting portion that extend from the line portion in a direction parallel to the address electrode, a third projection that projects from the first connecting portion in a direction parallel to the line portion, and a fourth projection that projects from the second connecting portion in the direction parallel to the line portion, wherein the third projection and the fourth projection are separated from each other.

In another aspect, a plasma display panel comprises a front substrate on which a scan electrode and a sustain electrode are positioned parallel to each other, a rear substrate on which an address electrode is positioned to cross the scan electrode and the sustain electrode, and a barrier rib that is positioned between the front substrate and the rear substrate to partition discharge cells, wherein each of the scan electrode and the sustain electrode includes a line portion crossing the address electrode, a first connecting portion and a second connecting portion that extend from the line portion in a direction parallel to the address electrode, a third projection that projects from the first connecting portion in an oblique direction, and a fourth projection that projects from the second connecting portion in an oblique direction, wherein the third projection and the fourth projection are separated from each other.

### ADVANTAGEOUS EFFECTS

A plasma display panel according to exemplary embodiments improves image quality by preventing an excessive reduction in a luminance of an image and improves a driving efficiency by reducing a discharge current.

### BRIEF DESCRIPTION OF THE DRAWINGS

The accompany drawings, which are included to provide a further understanding of the invention and are incorporated on and constitute a part of this specification, illustrate embodiments of the invention and together with the description serve to explain the principles of the invention. In the drawings:

FIG. 1 illustrates a structure of a plasma display panel;

FIG. 2 illustrates a scan electrode, a sustain electrode, and a black layer;

FIGS. 3 and 4 illustrate structures of a scan electrode and a sustain electrode;

FIG. 5 illustrates a discharge diffusion area;

FIGS. 6 and 7 illustrate sixth and seventh projections;

FIGS. 8 and 9 illustrate a projection direction of third and fourth projections;

FIG. 10 illustrates another structure of a scan electrode and a sustain electrode; and

FIGS. 11 and 12 illustrate another structure of a scan electrode and a sustain electrode.

### MODE FOR THE INVENTION

Reference will now be made in detail embodiments of the invention examples of which are illustrated in the accompanying drawings.

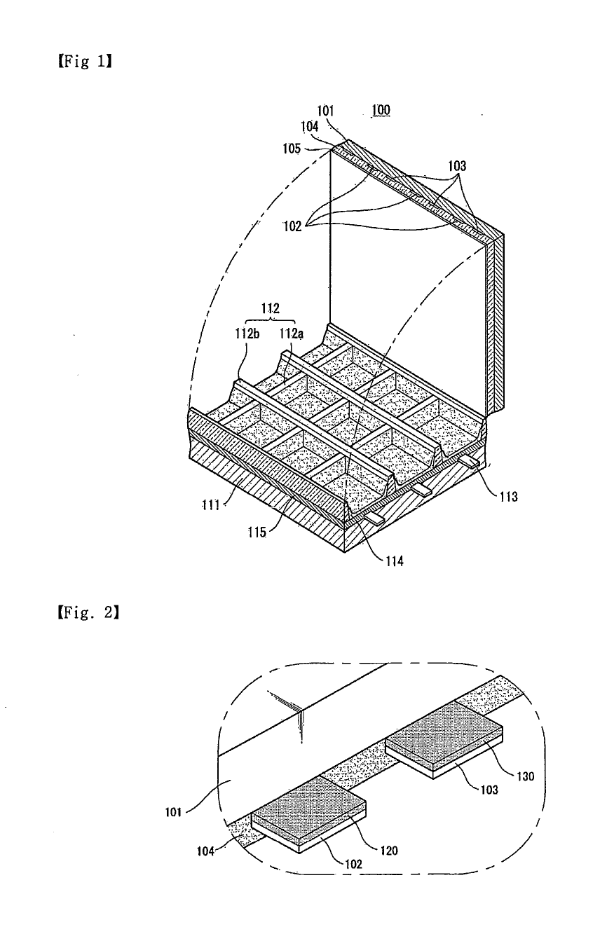

FIG. 1 illustrates a structure of a plasma display panel. As shown in FIG. 1, a plasma display panel 100 includes a front substrate 101 and a rear substrate 111. The front substrate 101 includes a scan electrode 102 and a sustain electrode 103 that are positioned parallel to each other, and the rear substrate 111 includes an address electrode 113 crossing the scan electrode 102 and the sustain electrode 103.

An upper dielectric layer 104 may be positioned on the scan electrode 102 and the sustain electrode 103 to limit a discharge current of the scan electrode 102 and the sustain electrode 103 and to provide electrical insulation between the scan electrode 102 and the sustain electrode 103. A protective layer 105 may be formed on the upper dielectric layer 104 to facilitate discharge conditions.

A lower dielectric layer 115 may be formed on the address electrode 113 to provide electrical insulation of the address electrodes 113. Barrier ribs 112 may be formed on the lower dielectric layer 115 to partition discharge cells. First, second, and third discharge cells respectively emitting red light, blue light, and green light may be formed between the front substrate 101 and the rear substrate 111.

The barrier rib 112 may include a first barrier rib 112a and a second barrier rib 112b crossing each other. A phosphor layer 114 may be formed inside the discharge cells partitioned by the barrier ribs 112 to emit visible light for an image display during an address discharge. For example, first, second, and third phosphor layers respectively producing red light, blue light, and green light may be formed inside the discharge cells.

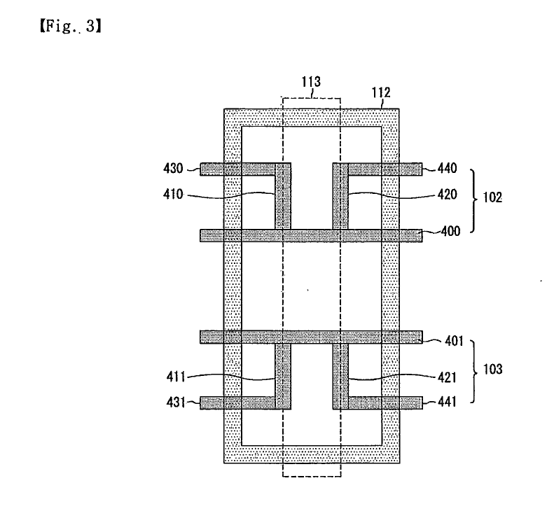

FIG. 2 illustrates the scan electrode 102, the sustain electrode 103, and a black layer. In FIG. 2, the scan electrode 102 and the sustain electrode 103 are bus electrodes in which a transparent electrode is omitted.

Black layers 120 and 130 may be positioned between the front substrate 101 and the scan and sustain electrodes 102 and 103, so as to improve a contrast characteristic of an image displayed on the panel by reducing a reflectance of the panel.

The scan electrode 102 and the sustain electrode 103 may be formed of a metal material with an excellent electrical conductivity which is easy to mold, for example, silver (Ag), gold (Au), and aluminum (Al). The Black layers 120 and 130 may include cobalt (Go) and ruthenium (Ru) with a relatively high degree of darkness.

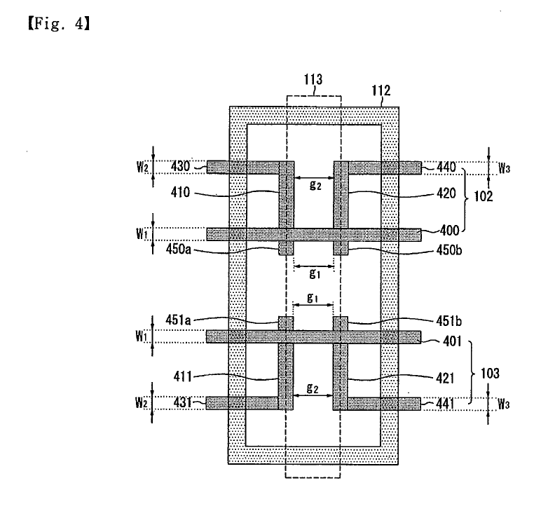

FIGS. 3 and 4 illustrate structures of the scan electrode 102 and the sustain electrode 103.

As shown in FIG. 3, the scan electrode 102 includes a line portion 400, a first connecting portion 410, a second connecting portion 420, a third projection 430, and a fourth projection 440. The sustain electrode 103 includes a line portion 401, a first connecting portion 411, a second connecting portion 421, a third projection 431, and a fourth projection 441.

The line portions 400 and 401 cross the address electrode 113. The connecting portions 410 and 420 extend from the line portion 400, and the connecting portions 411 and 421 extend from the line portion 401. The connecting portions 410, 411, 420 and 421 are parallel to the address electrode 113.

The third projections 430 and 431 may project from ends of the first connecting portions 410 and 411 in a direction parallel to the line portions 400 and 401. The fourth projections 440 and 441 may project from ends of the second connecting portions 420 and 421 in a direction parallel to the line portions 400 and 401.

It may be preferable that a projection direction of the third projections 430 and 431 is opposite to a projection direction of the fourth projections 440 and 441 so as to reduce an area of the discharge cell covered by the scan electrode 102 and the sustain electrode 103.

When a driving signal is supplied to the scan electrode 102 and the sustain electrode 103, a discharge starts to occur between the scan electrode 102 and the sustain electrode 103. Then, the discharge is diffused in the rear of the discharge cell through the first connecting portions 410 and 411, the second connecting portions 420 and 421, the third projections 430 and 431, and the fourth projections 440 and 441.

It is preferable that the first connecting portions 410 and 411 and the second connecting portions 420 and 421 extend in the rear of the discharge cell so as to easily diffuse the discharge occurring between the scan electrode 102 and the sustain electrode 103 in the rear of the discharge cell.

As shown in FIG. 4, the scan electrode 102 and the sustain electrode 103 may further include fifth projections 450a, 450b, 451a and 451b projecting from the line portions 400 and 410 toward the middle of the discharge cell. When a discharge starts to occur between the fifth projections 450a and 450b of the scan electrode 102 and the fifth projections 451a and 451b of the sustain electrode 103, a driving efficiency can be improved because a firing voltage between the scan electrode 102 and the sustain electrode 103 is lowered.

It is preferable that the fifth projections 450a, 450b, 451a and 451b are positioned in a straight line with the first connecting portion 410 and 411 or the second connecting portion 420 and 421, so as to easily diffuse the discharge occurring between the fifth projections 450a and 450b of the scan electrode 102 and the fifth projections 451a and 451b of the sustain electrode 103 in the rear of the discharge cell.

Although FIG. 4 illustrates the case where the scan electrode 102 and the sustain electrode 103 each include the two fifth projections, the number of fifth projections is not limited thereto.

Widths of the line portions 400 and 401 are W1, widths of the third projections 430 and 431 are W2, and widths of the fourth projections 440 and 441 are W3. The widths W1, W2 and W3 may be substantially equal to one another, and one of the widths W1, W2 or W3 may be different from the other widths.

Intervals g1 between the fifth projections 450a, 450b, 451a and 451b may be substantially equal to intervals g2 between the first connecting portion 410 and 411 and the second connecting portion 420 and 421.

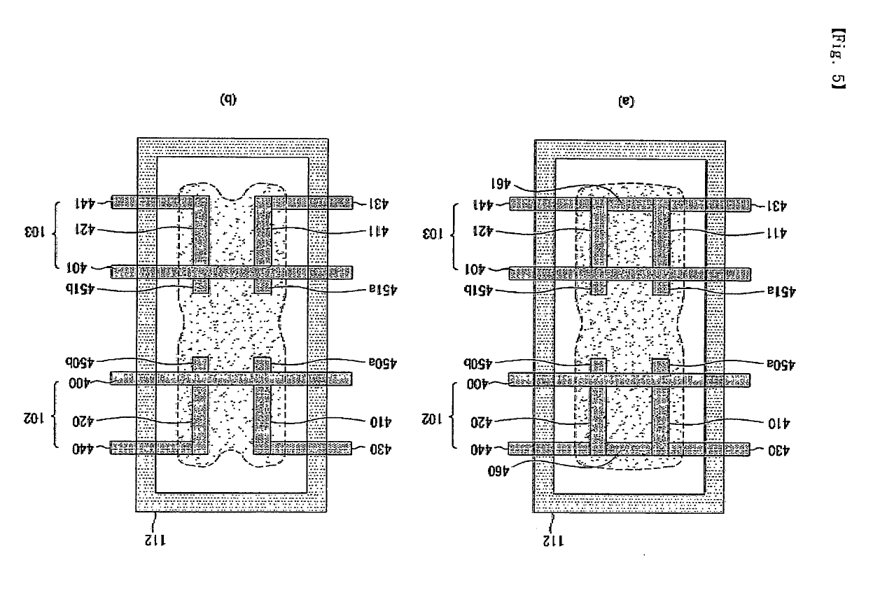

As shown in FIG. 5 illustrating a discharge diffusion area, (a) illustrates a case where the third projections 430 and 431 are connected to the fourth projections 440 and 441 through connecting portions 460 and 461, and (b) illustrates a case where the third projections 430 and 431 are separated from the fourth projections 440 and 441 at a predetermined distance therebetween.

A portion shown in dotted line in FIG. 5 indicates a discharge diffusion area inside the discharge cell. A relatively wide discharge diffusion area may mean that a luminaire is relatively high because a discharge is widely diffused. A relatively narrow discharge diffusion area may mean that a luminance is relatively low because a discharge is not smoothly diffused.

In (a) of FIG. 5, the discharge can be widely diffused by the connecting portions 460 and 461. However, because the connecting portions 460 and 461 excessively cover the discharge cell, the luminance may be reduced.

On the other hand, as shown in (b) of FIG. 5, when the third projections 430 and 431 are separated from the fourth projections 440 and 441, the discharge diffusion area in (b) is smaller than the discharge diffusion area in (a). However, an area of the discharge cell covered by the scan electrode 102 or the sustain electrode 103 can be reduced. Hence, the luminance in (b) can be larger than the luminance in (a).

Table 1 indicates consumption power and driving efficiency when an image with a full-white pattern is displayed on the screen of the plasma display panel in condition corresponding to each of (a) and (b) of FIG. 5.

TABLE 1

| | (a) of FIG. 5 | (b) of FIG. 5 |
|---|---|---|
| Consumption power (W) | 217 | 208 |
| Driving efficiency (lm/W) | 0.89 | 0.92 |

As indicated in Table 1, in the case of (a) of FIG. 5, the consumption power is about 217 W, and the driving efficiency is about 0.89 lm/W. In the case of (b) of FIG. 5, the consumption power is about 208 W, and the driving efficiency is about 0.92 lm/W. The consumption power in (b) of FIG. 5 is smaller than the consumption power in (a) of FIG. 5, and the driving efficiency in (b) of FIG. 5 is larger than the driving efficiency in (a) of FIG. 5. The reason is that a path of the discharge may lengthen and a reactive current may be reduced because the third projections 430 and 431 are separated from the fourth projections 440 and 441 in (b) of FIG. 5.

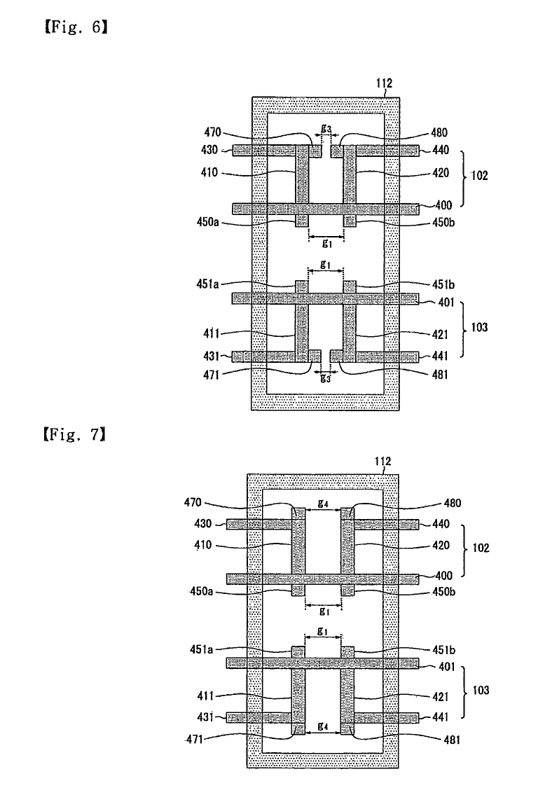

FIGS. 6 and 7 illustrate sixth and seventh projections.

As shown in FIG. 6, each of the scan electrode 102 and the sustain electrode 103 may include sixth projections 470 and 471 and seventh projections 480 and 481.

The sixth projections 470 and 471 project at a position where the first connecting portions 410 and 411 meet the third projections 430 and 431 in a direction different from a projection direction of the third projections 430 and 431. The seventh projections 480 and 481 project at positions where the second connecting portions 420 and 421 meet the fourth projections 440 and 441 in a direction different from a projection direction of the fourth projections 440 and 441. A projection direction of the sixth projections 470 and 471 may be opposite to a projection direction of the seventh projections 480 and 481.

The sixth projections 470 and 471 may be parallel to at least one of the line portions 400 and 401, the third projections 430 and 431, and the fourth projections 440 and 441. The seventh projections 480 and 481 may be parallel to at least one of the line portions 400 and 401, the third projections 430 and 431, and the fourth projections 440 and 441.

Intervals g3 between the sixth projections 470 and 471 and the seventh projections 480 and 481 may be smaller than the intervals g1 between the fifth projections 450a, 450b, 451a and 451b. Hence, a discharge occurring between the fifth projections 450a and 450b of the scan electrode 102 and the fifth projections 451a and 451b of the sustain electrode 103 can be easier diffused in the rear of the discharge cell.

As shown in FIG. 7, a projection direction of the sixth projections 470 and 471 may be parallel to a projection direction of the seventh projections 480 and 481. Intervals g4 between the sixth projections 470 and 471 and the seventh projections 480 and 481 may be substantially equal to the intervals g1 between the fifth projections 450a, 450b, 451a and 451b.

The sixth projections 470 and 471 may be positioned in a straight line with at least one of the first connecting portions 410 and 411 and the fifth projections 450a, 450b, 451a and 451b. The seventh projections 480 and 481 may be positioned in a straight line with at least one of the second connecting portions 420 and 421 and the fifth projections 450a, 450b, 451a and 451b. Hence, a discharge occurring between the fifth projections 450a and 450b of the scan electrode 102 and the fifth projections 451a and 451b of the sustain electrode 103 can be easier diffused in the rear of the discharge cell.

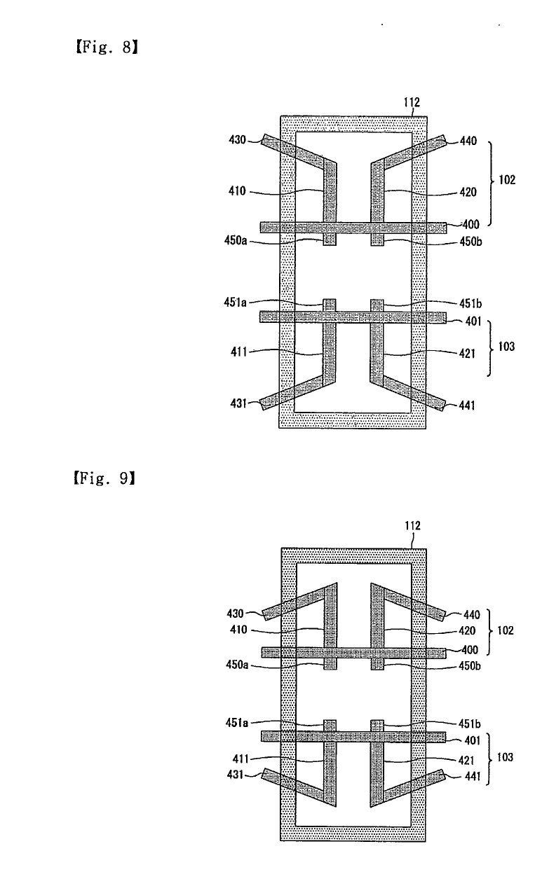

As shown in FIGS. 8 and 9 illustrating a projection direction of the third and fourth projections, the third projections 430 and 431 and the fourth projections 440 and 441 are not parallel to the line portion 400 and 401 and may be positioned in an oblique direction. Hence, a discharge occurring between the fifth projections 450a and 450b of the scan electrode 102 and the fifth projections 451a and 451b of the sustain electrode 103 can be easier diffused in the rear of the discharge cell.

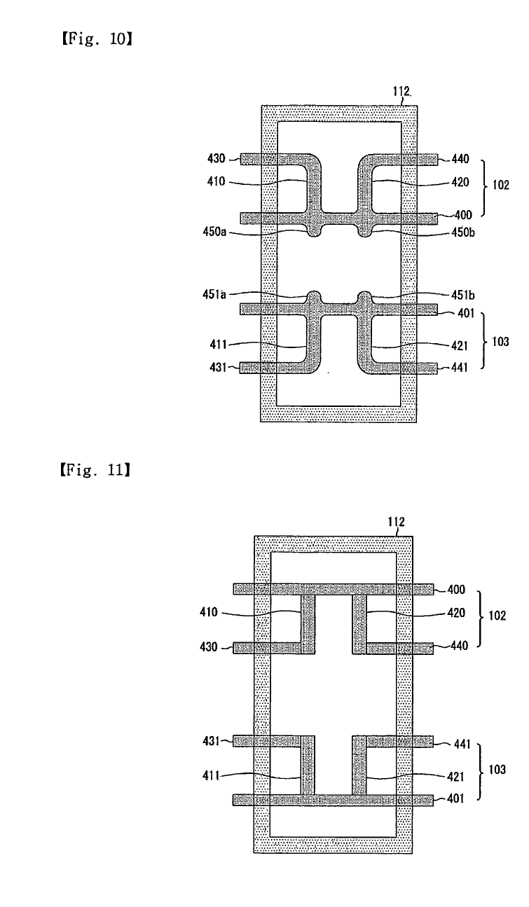

As shown in FIG. 10 illustrating another structure of the scan electrode 102 and the sustain electrode 103, each of the scan electrode 102 and the sustain electrode 103 may have a curvature in a portion where the first connecting portions 410 and 411 meet the third projections 430 and 431 and a portion where the second connecting portions 420 and 421 meet the fourth projections 440 and 441. Further, the fifth projections 450a, 450b, 451a and 451b may include a portion having a curvature.

In the structure of the scan and sustain electrodes 102 and 103 shown in FIG. 10, the scan and sustain electrodes 102 and 103 can be easier manufactured. Further, the wall charges can be prevented from being excessively accumulated at a specific location during a drive, and thus the plasma display panel can be driven stably.

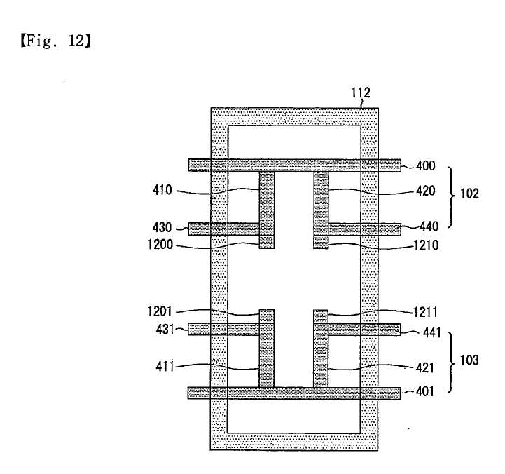

FIGS. 11 and 12 illustrate another structure of the scan electrode 102 and the sustain electrode 103.

As shown in FIG. 11, in the scan electrode 102 and the sustain electrode 103, the first connecting portions 410 and 411 and the second connecting portions 420 and 421 projecting from the line portion 400 and 401 may project toward the middle of the discharge cell. The scan electrode 102 and the sustain electrode 103 may include third projections 430 and 431 projecting from an end of the first connecting portions 410 and 411 in a direction different from the first connecting portions 410 and 411, and fourth projections 440 and 441 projecting from an end of the second connecting portions 420 and 421 in a direction different from the second connecting portions 420 and 421.

In this case, discharges may start to occur between the third and fourth projections 430 and 440 of the scan electrode 102 and the third and fourth projections 431 and 441 of the sustain electrode 103. The discharges may be diffused toward the line portion 400 and 401 along the first connecting portions 410 and 411 and the second connecting portions 420 and 421.

In the structure of the scan and sustain electrodes 102 and 103 shown in FIG. 11, a middle portion of the discharge cell where a relatively large amount of visible light is generated can be prevented from being covered, and thus a luminance of an image can be improved.

As shown in FIG. 12, each of the scan electrode 102 and the sustain electrode 103 may include eighth portions 1200 and 1201 projecting at positions where the first connecting portions 410 and 411 meet the third projections 430 and 431 in a direction different from projection directions of the first connecting portions 410 and 411 and the third projections 430 and 431, and ninth portions 1210 and 1211 projecting at positions where the second connecting portions 420 and 421 meet the fourth projections 440 and 441 in a direction different from projection directions of the second connecting portions 420 and 421 and the fourth projections 440 and 441.

Because discharges may start to occur between the eighth portions 1200 and 1201 and between the ninth portions 1210 and 1211, a driving voltage can be lowered. Hence, the driving efficiency can be improved.

The eighth portions 1200 and 1201 may be positioned in a straight line with the first connecting portions 410 and 411, and the ninth portions 1210 and 1211 may be positioned in a straight line with the second connecting portions 420 and 421. Hence, the discharge occurring between the eighth portions 1200 and 1201 and between the ninth portions 1210 and 1211 can be easier diffused in the rear of discharge cell.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art.

1. A plasma display panel comprising:
a front substrate on which a scan electrode and a sustain electrode are positioned parallel to each other;
a rear substrate on which an address electrode is positioned to cross the scan electrode and the sustain electrode; and
a barrier rib that is positioned between the front substrate and the rear substrate to partition discharge cells,
wherein each of the scan electrode and the sustain electrode includes:
a line portion crossing the address electrode;
a first connecting portion and a second connecting portion that extend from the line portion in a direction parallel to the address electrode;
a third projection that projects from the first connecting portion in a direction parallel to the line portion; and
a fourth projection that projects from the second connecting portion in the direction parallel to the line portion,
wherein the third projection and the fourth projection are separated from each other.

2. The plasma display panel of claim 1, wherein the first connecting portion and the second connecting portion project in the rear of the discharge cell.

3. The plasma display panel of claim 1, wherein the scan electrode and the sustain electrode are bus electrodes.

4. The plasma display panel of claim 1, wherein each of the scan electrode and the sustain electrode further includes at a least fifth projection projecting from the line portion in a direction opposite a projection direction of at least one of the first and second connecting portions.

5. The plasma display panel of claim 4, wherein the fifth projection is positioned in a straight line with at least one of the first and second connecting portions.

6. The plasma display panel of claim 1, wherein a portion where the first connecting portion meets the third projection and a portion where the second connecting portion meets the fourth projection have curvatures.

7. The plasma display panel of claim 1, wherein each of the scan electrode and the sustain electrode further includes a sixth projection projecting at a position where the first connecting portion meets the third projection in a direction different from projection directions of the first connecting portion and the third projection.

8. The plasma display panel of claim 1, wherein each of the scan electrode and the sustain electrode further includes a seventh projection projecting at a position where the second connecting portion meets the fourth projection in a direction different from projection directions of the second connecting portion and the fourth projection.

9. The plasma display panel of claim 1, wherein a projection direction of the third projection is opposite to a projection direction of the fourth projection.

10. A plasma display panel comprising:
a front substrate on which a scan electrode and a sustain electrode are positioned parallel to each other;
a rear substrate on which an address electrode is positioned to cross the scan electrode and the sustain electrode; and
a barrier rib that is positioned between the front substrate and the rear substrate to partition discharge cells,
wherein each of the scan electrode and the sustain electrode includes:
a line portion crossing the address electrode;
a first connecting portion and a second connecting portion that extend from the line portion in a direction parallel to the address electrode;
a third projection that projects from the first connecting portion in an oblique direction; and
a fourth projection that projects from the second connecting portion in an oblique direction,
wherein the third projection and the fourth projection are separated from each other.

11. The plasma display panel of claim 10, wherein the first connecting portion and the second connecting portion project in the rear of the discharge cell.

12. The plasma display panel of claim 10, wherein the scan electrode and the sustain electrode are bus electrodes.

13. The plasma display panel of claim 10, wherein each of the scan electrode and the sustain electrode includes an eighth portion projecting at a position where the first connecting portion meets the third projection in a direction different from projection directions of the first connecting portion and the third projection.

14. The plasma display panel of claim 10, wherein each of the scan electrode and the sustain electrode includes a ninth portion projecting at a position where the second connecting portion meets the fourth projection in a direction different from projection directions of the second connecting portion and the fourth projection.
